(19) United States
(12) Patent Application Publication
(10) Pub. No.: US 2024/0051154 A1
(43) Pub. Date: Feb. 15, 2024

(54) Leg-Stub Re-Swing for Legged Robot

(71) Applicant: Ghost Robotics Corporation, Philadelphia, PA (US)

(72) Inventors: Jeffrey Duperret, Philadelphia, PA (US); Avik De, Philadelphia, PA (US)

(21) Appl. No.: 18/232,180

(22) Filed: Aug. 9, 2023

Related U.S. Application Data
(60) Provisional application No. 63/396,343, filed on Aug. 9, 2022.

(51) Int. Cl. B25J 13/08; B62D 57/032; B25J 9/16; B25J 9/10

(52) U.S. Cl. CPC B25J 13/084; B62D 57/032; B25J 9/1666; B25J 13/088; B25J 9/102

(57) ABSTRACT

The present invention regards a reflex algorithm for a legged robot upon detecting an unexpected contact in order to reach a desired touchdown location using a leg stub re-swing. The proprioceptive leg-stub re-swing algorithm is a two-phase algorithm that is particularly beneficial in environments with unstructured terrain and wherein vision sensors may be damaged upon contact with protruding obstacles.

### BACKGROUND OF THE INVENTION

Legged robots are capable of traversing more unstructured terrain compared to their wheeled counterparts. These legged robots are advantageous when it comes to traversing obstacles that need to be stepped over, as they can utilize isolated footholds. Legged robots have unique legs that bear isolated footholds and robots with legs actuated in more than one degree freedom can apply forces in multiple directions as opposed to their single actuated degree of freedom counterparts. These developments have made multi-legged robots extremely advanced.

While there have been developments in quadruped technology, perfecting the gait and the locomotive abilities of a legged robot have proven to be a difficult task. Legged robots require legs to be frequently repositioned to continue moving whereas wheeled ones can continuously apply force on to their environment. A robot using only one leg to locomote will run out of workspace in its leg if the leg's end effector is in contact with the environment at rest and the robot body is moving away from this location of environmental contact. Leg forces during recirculation can be immense and apply unwanted wrenches on a robot's body because of unexpected contact with obstacles.

Multiple approaches have been implemented to solve the issue of unexpected gait obstacles. Previous optimizations have proposed a controller that can react to stub events by re-generating the swing trajectory in an online fashion but assume that the obstacle is always a cinder-block style step with a known height and that it is merely at an uncertain horizontal position with respect to the robot. The present invention does not assume such geometry about the obstacle and disregards the assumption that the obstacle's height is less than the originally planned swing path.

For example, some quadruped or biped robots utilize exteroception to observe the terrain, or rely on pre-determined knowledge of the terrain, and calculate the swing path of their limbs and accordingly to avoid obstacles during swing. While this can remedy the issue at the basic level, swing obstacles may present themselves unexpectedly due to uncertain knowledge of the leg's position in the world, insufficient visibility, or shifting terrain. The present invention remedies the issue by proprioceptively feeling an obstacle with the toe or foot of the quadruped robot during unexpected contact and instinctively, or reactively avoid further contact by swinging over the obstacle. The approach utilized by the present invention does not solely rely on vision-based sensors, with the downsides as mentioned above.

### SUMMARY OF THE INVENTION

The present invention pertains to a leg stub re-swing reflex algorithm for a robot, such as a biped, quadruped, or other legged robot. A legged robot comprises of a robotic system with one or more appendages used for locomotion. Legged robots locomote through their environments by exerting reaction forces on the environment using forces generated by the leg wherein the leg is somehow in contact with environmental matter.

The assumption herein is that a legged robot's body moves in a particular direction, and the leg in contact with the environment will eventually run out of workspace and will—without re-placing the leg to a different location in the environment—reach a configuration in which it no longer can generate ground-reaction forces effectively on the robot body. Thus, the legged robot will command the leg to break contact with the environment so that the leg can regain contact with the environment in some other region of its workspace so as to exert ground-reaction forces on the robot body in a more suitable manner. The repositioning of the leg in its environment is considered a leg “swing” and in the present invention, a swing contains a nominal desired trajectory from the liftoff to the desired touchdown location which is approximately followed or tracked by the leg via any control method, either employing an open-loop or closed-loop method. If the leg of the robot somehow contacts the environment before reaching its intended placement location in the environment during swing, a stub event occurs.

A proprioceptive leg-stub re-swing is a reflex algorithm for a legged robot in which, proprioceptive methods are used to detect unexpected contact between the environment and any part of the leg during its swing phase. Next, upon detecting an unexpected contact, the swing path of the leg is re-created to start from the current position of the leg with the goal to reach the desired touchdown location, with the effect that the actuators lift the toe up and over the unexpected contact. Proprioceptive sensors provide information about the position, orientation, and velocity of the robot's parts, and include sensors like encoders, gyroscopes, and accelerometers.

During a swing, a leg can proprioceptively detect a stub event. In particular, legged robots are capable of detecting stub events using the motors alone; including but not limited to encoder sensors and current sensors, as well as inertial measurement units (IMUs) as sensor data without the use of any dedicated contact sensors or explicit force/torque sensors not inherent to the motor, as well as any algorithmic calculations such as the legs time-of-flight or swing phase that aren't direct functions of sensor measurements. A robotic leg's transmission and motor gearing configuration are assumed to be backdrivable enough to enable proprioceptive detection of stub events. The proprioceptive sensor data may be interpreted by methods based on physics models or machine learning components, to identify an unexpected contact event.

One example wherein this improvement is best applied is in a staircase, a curb, or other type of ground format wherein a portion is substantially raised, and the touchdown calculation requires an adjustment to avoid a collision or fall.

An advantage of this proprioceptive re-swing method includes a robustness to terrain irregularities that may not be able to be detected with non-proprioceptive methods, such as being able to step over a rock in tall grass where the grass occludes vision sensors from seeing the rock. Another advantage is that the fundamental task of achieving the desired leg-environment touchdown location at a specific time need not be modified (or modified significantly) even in the event of unwanted environmental contact in swing, an advantage owed to using a leg capable of both a fast dynamical response and proprioceptive detection. This allows for more rapid locomotion as compared to on/with more classical quasi-static platforms/methods.

The present invention enables the leg to proprioceptively “feel” the curb as a part of the leg impacts it, according to phase one of the operation, which then allows the robot limb to swing its leg over the curb reactively to avoid the toe getting caught and potentially causing a stumble or fall, thereby entering phase two. This approach is much more effective as vision sensors are not always ideal in certain environments such as tall grass or smoke, or when there are obstacles that may protrude and impact and crack the lenses used. Moreover, in certain aggressive environments, there is a likelihood of lenses being cracked or damaged, especially in unstructured terrain. As a result, an algorithm such as the reflex algorithm is more suitable for these unique environments.

The algorithm's swing is divided into two phases that combine proprioceptive detection methods with modifications of a robot leg's swing trajectory in an online manner to attempt to clear the obstacle that takes advantage of the leg's capability for a dynamic response, allowing rapid navigation of the obstacle without necessarily changing the spatio-temporal “goal” of reaching a suitable touchdown event in a way that will slow down the robot.

Phase one of the present invention includes proprioceptive stub detection to prevent unwanted environmental contact. An observer of the leg dynamics detects an external force on the leg that exceeds a certain threshold in its Cartesian components during swing and in a prescribed time interval before touchdown. This detected external force constitutes a “stub” detection. Phase one in the proprioceptive environmental contact detection phase operates nominally during swing but can either be turned off, so that environmental contacts at certain parts of the swing are ignored. This ability is significant as it avoids false detections of the ground during liftoff. Methods for Phase 1 stub detection can constitute any method utilizing proprioceptive sensors but may also be as simple as an observer of the leg dynamics detects an estimated external force that exceeds a certain threshold in its Cartesian components during swing and in a prescribed time interval before touchdown.

Phase two of the present invention is the re-swing response. The leg initiates its swing again, but as opposed to starting at the nominal liftoff location, the leg swing starts from the stub location. The apex height of the swing is increased (among other possible changes to the swing path) in order to increase the chances of getting over the unexpected contact with an obstacle or intrusion. This proprioceptive reflex provides locomotive robustness to unexpected contacts and gives the legged robot an opportunity to correct for the unexpected contact before the event applies a large unwanted wrench on the body which could lead to falling over, collisions, and other damaging contact. In phase two, the nominal desired swing path is modified so as to attempt to clear the obstacle in a “re-swing.” Once the trajectory has been modified the leg is optionally allowed to enter Phase 1 again, so that the robot's control algorithm can be programmed to re-swing one or more times depending on robot parameters and conditions. Multiple re-swings can be required to scale an obstacle proprioceptively, and the ability to re-swing multiple times can be allowed or disallowed by the computer software controlling the robot.

In this phase, the leg modifies its swing path such that the path now vertically clears the unwanted point of environmental contact. In one embodiment of the present invention, the leg may be commanded to initiate its swing again, but as opposed to starting at the nominal liftoff location, it can start it from the stub location and the apex height of the desired swing trajectory can be increased so as to vertically clear the current location of contact and increase the chances of getting over the unexpected obstacle, even if it extends more vertically up than the current location of contact.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a depiction of the present invention's legged robot.

FIG. 2 is a diagram of the re-swing phase 1 and 2 state machine.

FIG. 3 is an embodiment of the present invention going up a curb without vision-based sensors with normal walking gait without prior knowledge of the curb.

FIG. 4 is the re-swing response with the legged robot's new swing path outlined by the dotted line.

FIG. 5 is the anatomy of a legged robot.

FIG. 6A is a depiction of an original (solid) and modified (dashed) swing trajectory resulting from Phase 1 detecting an impact with the dotted curb and Phase 2 modifying the desired swing trajectory.

FIG. 6B represents multiple re-swings that can be used to clear a taller obstacle, as further explained in the text.

FIG. 6C depicts the re-swing trajectory landing on top of the obstacle to use it as a foothold.

### DETAILED DESCRIPTION OF THE PREFERRED EMBODIMENT

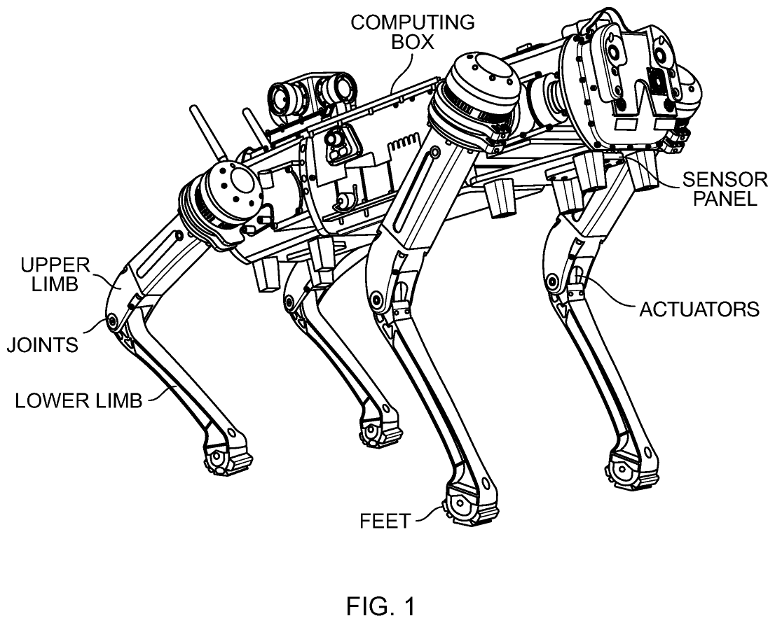

FIG. 1 is a depiction of the present invention's legged robot. The legged robot features a computing box, which houses IMUs and processors to execute algorithms and commands. The legged robot also features an upper and lower limb, connected by way of actuators. The legged robot may also feature an array of sensors within the sensor panel.

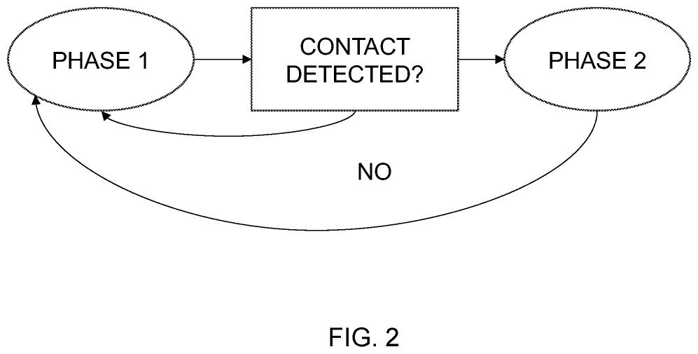

FIG. 2 is a diagram of the re-swing phase 1 and 2 state machine. If contact is detected, phase 1 is utilized.

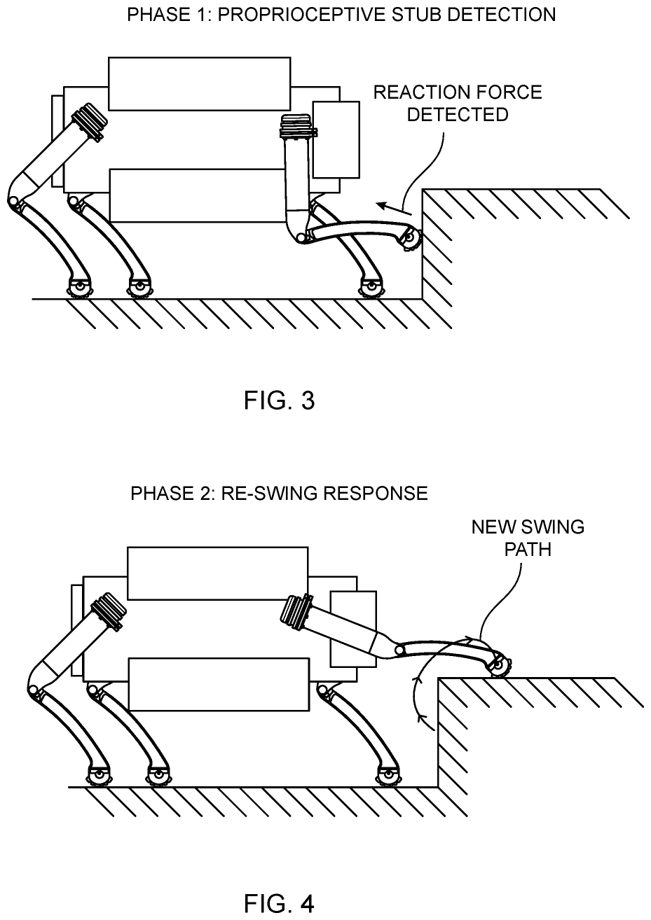

FIG. 3 is an embodiment of the present invention going up a curb without vision-based sensors with normal walking gait without prior knowledge of the curb. An observer of the leg dynamics detects an external force that exceeds a certain threshold in its Cartesian components during swing and in a prescribed time interval before touchdown. This constitutes a “stub” detection.

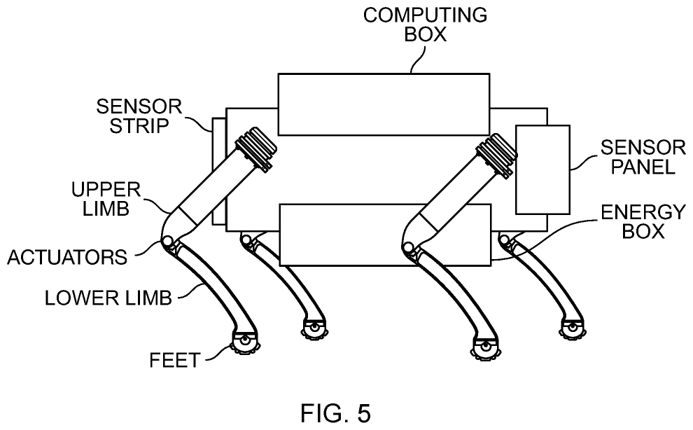

FIG. 4 is the re-swing response with the legged robot's new swing path outlined by the dotted line. The leg initiates its swing again, but instead of starting at the nominal liftoff location we start it from the stub location. The apex height of the swing is increased so as to increase the chances of getting over the unexpected contact.

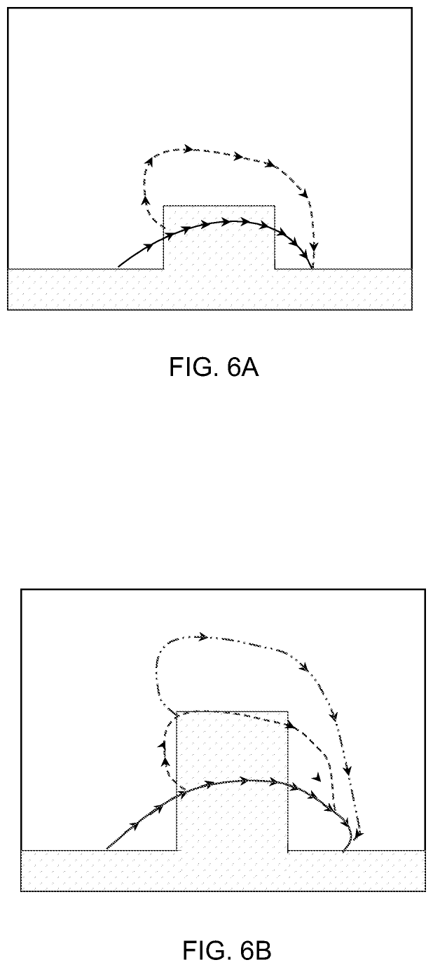

FIG. 5 is the anatomy of a legged robot.

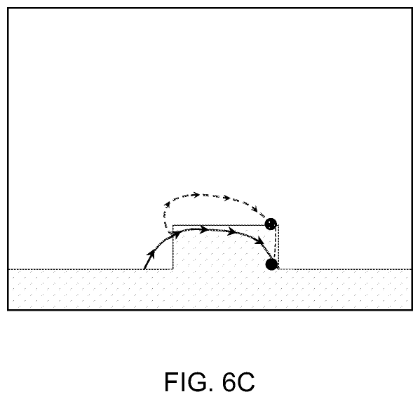

FIG. 6A is a depiction of an original (solid) and modified (dashed) swing trajectory resulting from Phase 1 detecting an impact with the dotted curb and Phase 2 modifying the desired swing trajectory. The speed of swing can be increased so as to not require modification of the robot's step timings. An example of such a trajectory re-planning is given in FIG. 4. This re-calculation of the swing trajectory can be done in an online manner fast if the original swing trajectory is parameterized in a compact form and that these parameters can be suitably modified as a function of the location of stub. Achievement of more aggressive re-swing trajectories as compared to on traditional quasi-static machines are made possible via the proprioceptive leg transmission.

FIG. 6B shows a case where multiple re-swings can be used to robustly clear a taller obstacle. The first swing (solid line) impacts the obstacle, then the second (dashed) retracts and impacts the obstacle at a higher point. Finally—as the height of the desired trajectory is increased after each impact and re-swing—the third swing (dotted and dashed) clears the obstacle. The conditions for when to allow or not allow a subsequent re-swing can be programmed based on the environment, task at hand, and state of the robot.

FIG. 6C depicts a re-swing being used to step on top of an obstacle to be used as a foothold. By only allowing re-swings during a middle portion of the desired swing trajectory the re-swing algorithm can be robust to touching down on terrain above (or below) the original desired landing height. For example, when stepping up a curb proprioceptively the robot may not know (via lack of exteroception sensing) that the terrain height increases thus the original landing height is impossible to achieve.

In this case the original swing trajectory (solid line) hits the edge of the curb (raised and dotted), then re-swings (dashed line). The solid lines of each desired trajectory represent an allowed portion of the swing to re-swing and the dashed lines of each desired trajectory represent a portion of swing in which re-swings will not be allowed. Instead, the robot could be commanded to power-through the first dotted portion and assume an impact in the second dotted portion is an admissible touchdown. When the second re-swing impacts the ground pre-maturely at the dotted black circle, it is above the original desired landing (solid black circle) in height, however because it is outside of the range in which a re-swing is allowed the leg simply touches down instead of attempting to re-swing again, thus successfully touching down on top of the curb.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A method for a leg-stub detection for a legged robot, the method comprising,
generating, by way of proprioceptive sensors housed inside of a computing box, data regarding the positioning, orientation, and velocity of a legged robot's parts,
detecting an external force that exceeds a threshold in its Cartesian components during swing in a prescribed time interval prior to touchdown,
detecting an obstacle, wherein said obstacle causes an interference in a path of said legged robot, and;
executing a proprioceptive leg-stub re-swing reflex algorithm by way of a processor housed inside of a computing box, wherein said legged robot establishes a new swing path in response to the detection of said obstacle.

2. The method according to claim 1, wherein a leg of said legged robot responds with said re-swing reflex, comprising of restarting a swing phase of a leg of said legged robot that is initiated at a current position of said leg to reach an original touchdown location and execute a new swing path.

3. The method according to claim 1, wherein said proprioceptive sensors include motor sensors, and include encoders, gyroscopes, and accelerometers to provide information about the position, orientation, and velocity of said legged robot.

4. The method according to claim 3, further comprising of motor sensors and a leg transmission of said legged robot to detect environmental contact.

5. The method according to claim 1, wherein said leg of said legged robot is capable of absorbing repeated episodes of environmental contact.

6. The method according to claim 4, wherein said leg transmission and a motor gearing configuration are back drivable to enable proprioceptive detection of a plurality of stub events.

7. The method according to claim 2, wherein an apex height of a reswing trajectory is augmented to increase a probability of getting over unexpected contact.

8. The method according to claim 2, wherein a swing frequency of said reswing trajectory is increased to reach said touchdown location at an anticipated time for said touchdown regardless of said obstacle.

9. The method according to claim 2, wherein at least one stub detection is allowed to occur during a specified time interval during the execution of a first reswing trajectory.

10. The method according to claim 9, wherein a second reswing is allowed to occur following a second stub detection during execution of the said first reswing trajectory.

11. The method according to claim 10, wherein a maximum number of reswings is 2 or greater, limited to a pre-determined number, and during an execution of a last reswing, said stub does not trigger said reswing again.

12. A method for a leg-stub re-swing for a legged robot, the method comprising,
generating, by way of proprioceptive sensors including at least one encoder, gyroscope, and accelerometer to provide information about the position, orientation, and velocity of said legged robot, and wherein said proprioceptive sensors are housed inside of a computing box, data regarding the position, orientation, and velocity of a legged robot's parts,
detecting an external force that exceeds a threshold in its Cartesian components during swing in a prescribed time interval prior to touchdown,
detecting an obstacle, wherein said obstacle causes an interference in locomotion of a legged robot, and;
executing a proprioceptive leg-stub re-swing reflex algorithm by way of a processor housed inside of a computing box,
increasing an apex height of a swing trajectory of a legged robot to get over unexpected environmental contact, and;
wherein said legged robot breaks contact with said obstacle and interference and establishes a new swing path in response to the detection of said obstacle.

13. The method according to claim 12, further comprising of motor sensors and a leg transmission of said legged robot to detect environmental contact.

14. The method according to claim 12, wherein said leg of said legged robot is capable of absorbing repeated episodes environmental contact.

15. The method according to claim 13, wherein said leg transmission and a motor gearing configuration are back drivable to enable proprioceptive detection of stub events.

16. The method according to claim 12, further comprising of said proprioceptive detection of stub events dynamically alter the swing trajectory of said leg belonging to said legged robot.

17. The method according to claim 12, wherein said legged robot navigates unstructured terrain using said proprioceptive leg-stub re-swing reflex algorithm.

18. The method according to claim 17, wherein said legged robot's said swing trajectory is parameterized in a compact form and can be modified as a function of the location of said stub during said stub event.

19. A system for a leg-stub re-swing for a legged robot, the system comprising of:
a legged robot, composed of upper limbs, lower limbs, and feet, and wherein said upper limbs and lower limbs are attached by way of screw actuators,
a sensor panel for proprioceptive sensors, including encoders, gyroscopes, and accelerometers to provide information about the position, orientation, and velocity of said legged robot,
a computing box, housing an inertial measurement unit, configured to execute a proprioceptive leg-stub re-swing reflex algorithm, and wherein said proprioceptive leg-stub reflex algorithm detects a toe-stub event upon impact with an obstacle, and;
a plurality of joint actuators, capable of enabling said legged robot to swing said leg over said obstacle upon said impact.

20. The system according to claim 19, wherein said legged robot comprises of a plurality of legs for movement through unstructured terrain.

21. The system according to claim 20, wherein said computing box is situated between upper and lower extremities of said legged robot.

22. The system according to claim 19, wherein said leg-stub reflex algorithm utilizes reflexive replanning without assumptions regarding a known height of a potential obstacle.
